(19) United States
(12) Patent Application Publication
(10) Pub. No.: US 2017/0012318 A1
(43) Pub. Date: Jan. 12, 2017

(54) METHOD OF PREPARING SOLID ELECTROLYTE COMPOSITION FOR LITHIUM SECONDARY BATTERY

(71) Applicants: JEONGKWAN CO., LTD, Yangsan-si Gyeongsangnam-do (KR); JEONGKWAN DISPLAY CO., LTD, Asan-si Chungcheongnam-do (KR)

(72) Inventors: Taeheung KIM, Busan (KR); Jaeeun SONG, Yangsan-si, Gyeongsangnam-do (KR); Duckki YOON, Busan (KR); Hyungsik LIM, Busan (KR); Daeyeon GO, Ulsan (KR)

(73) Assignees: JEONGKWAN CO., LTD, Yangsan-si, Gyeongsangnam-do (KR); JEONGKWAN DISPLAY CO., LTD, Asan-si, Chungcheongnam-do (KR)

(21) Appl. No.: 15/114,406

(22) PCT Filed: Sep. 2, 2015
(86) PCT No.: PCT/KR2015/009256

§ 371 Date: Jul. 27, 2016

(30) Foreign Application Priority Data
Feb. 26, 2015 (KR) 10-2015-0027616

(51) Int. Cl. H01M 10/0562; C03B 11/12; C03C 3/062; C03C 23/00; C03C 4/14; H01M 10/052; C03B 32/02

(52) U.S. Cl. CPC H01M 10/0562; H01M 10/052; C03B 11/122; C03B 32/02; C03C 23/007; C03C 4/14; C03C 3/062; H01M 2300/0071; C03B 2215/06; C03B 2215/07

(57) ABSTRACT

Disclosed is a method of preparing a solid electrolyte composition for a lithium secondary battery which includes: (a) mixing materials including Li₂O, SiO₂, TiO₂, P₂O₅, BaO, Cs₂O and V₂O₅; (b) melting the mixed materials; (c) rapidly cooling the molten materials at room temperature and compressing the molten materials using a preheated plate to form electrolyte glass having a predetermined thickness; (d) heating the electrolyte glass to eliminate stress at a predetermined temperature range; (e) heating the electrolyte glass to a higher temperature range higher than in the step of heating the electrolyte glass to eliminate stress to be crystallized; and (f) precisely adjusting a thickness of the electrolyte glass by lapping the electrolyte glass.

### TECHNICAL FIELD

The present invention relates to a solid electrolyte composition for a lithium secondary battery, and more specifically, to a method of preparing a solid electrolyte composition for a lithium secondary battery, which has high ionic conductivity and excellent thermal and mechanical properties, and is easy to handle.

### BACKGROUND ART

In recent years, handheld devices such as a smartphone, a tablet PC or the like have become a vital part of our everyday lives. It is no exaggeration to say that technical advances in all batteries allowed this to be realized. Especially, a lithium-ion secondary battery has rapidly developed as a main power source with the spread of mobile devices such as a smartphone, a tablet PC or the like due to its high energy density and output voltage since mass production started in 1991.

However, the lithium-ion secondary battery has a risk of explosion when an organic electrolyte solution used for the movement of lithium ions is in an overheated and overcharged state, and is flammable in the presence of an ignition source. Further, the lithium-ion secondary battery has a disadvantage in that gas is generated when a side reaction occurs in the cell, resulting in a decrease in performance and stability of the battery.

An all-solid battery which may overcome these drawbacks and is the ultimate goal of technological development may especially have a significantly improved stability because there is no occurrence of ignition and explosion due to electrolyte decomposition by its core technology of replacing a liquid electrolyte with a solid electrolyte. Further, the all-solid battery has an advantage in that energy density with respect to mass and volume of the battery may be dramatically enhanced because lithium metal or a lithium alloy may be used as a negative electrode material.

However, since the solid electrolyte has a problem of ionic conductivity being lower than that of a liquid electrolyte and a poor electrode/electrolyte interfacial state, the performance of the battery is lowered when used.

In order to address the above-described problems, the present applicant has proposed a solid electrolyte composition for a lithium secondary battery and a method of preparing the same, having Li₂O, SiO₂, TiO₂ and P₂O₅ components, containing BaO and Cs₂O to impart mechanical strength and including V₂O₅ to increase lithium ion conductivity as disclosed in Korean Patent Publication No. 10-1324729.

However, the preparation method disclosed in Korean Patent Publication No. 10-1324729 still has a limitation in increasing lithium ion conductivity although lithium ion conductivity of a solid electrolyte composition is significantly increased compared to an existing solid electrolyte composition.

### DISCLOSURE

### Technical Problem

In order to solve the above-described problems, an object of the present invention is to provide a method of preparing a glass-type solid electrolyte composition for a lithium secondary battery having improved lithium (Li) ion conductivity by minimizing defects and cracks which are factors for reducing resistance at the interface and generated in the process of heat treating the solid electrolyte and increasing crystallinity so as to increase the lower ionic conductivity as compared to a liquid electrolyte and enhance the state of the contact interface between the solid electrolyte and electrode materials.

### TECHNICAL SOLUTION

In order to achieve the objective of the present invention, a method of preparing a solid electrolyte composition for a lithium secondary battery according to an aspect of the present invention includes: (a) mixing materials including Li₂O, SiO₂, TiO₂, P₂O₅, BaO, Cs₂O and V₂O₅; (b) melting the mixed materials; (c) rapidly cooling the molten materials at room temperature and compressing the molten materials to form electrolyte glass having a predetermined thickness; (d) heating the electrolyte glass to eliminate stress at a predetermined temperature range; (e) heating the electrolyte glass to a temperature range higher than that in the step of heating the electrolyte glass to eliminate stress to be crystallized; and (f) precisely adjusting a thickness of the electrolyte glass by lapping the electrolyte glass.

A method of preparing a solid electrolyte composition for a lithium secondary battery according to another aspect of the present invention includes: (a) mixing 5 to 8 wt % of Li₂O, 2 to 5 wt % of SiO₂, 30 to 35 wt % of TiO₂, 56 to 60 wt % of P₂O₅, 0.1 to 2 wt % of BaO, 0.1 to 2 wt % of Cs₂O and 0.5 to 2 wt % of V₂O₅; (b) introducing the mixed materials into a platinum crucible and heating the mixed materials at a rate of 10° C./min to melt in an air atmosphere at a temperature of 1300 to 1450° C.; (c) rapidly cooling the molten materials at room temperature and compressing the molten materials using a preheated carbon plate to form electrolyte glass having a predetermined thickness; (d) heating the electrolyte glass at a rate of 10° C./min to eliminate stress at 500 to 600° C.; (e) heating the electrolyte glass at a rate of 10° C./h and maintaining the electrolyte glass in an air atmosphere at a temperature of 900 to 1000° C. for 5 to 15 hours to be crystallized; and (f) precisely adjusting a thickness of the electrolyte glass by lapping the electrolyte glass.

### ADVANTAGEOUS EFFECTS

The solid electrolyte composition for a lithium secondary battery prepared by the method of the present invention is determined to have a lithium ion conductivity of 6.5×10⁻⁴ S/cm which is increased about sixfold compared to an existing solid electrolyte, and has improved discharge capacity and stability.

### DESCRIPTION OF DRAWINGS

FIG. 1 is a flow chart illustrating a method of preparing a solid electrolyte composition for a lithium secondary battery according to an embodiment of the present invention.

FIG. 2 is a graph showing impedance data (measurement equipment: Zennium impedance measurement analyzer manufactured by ZAHNER-elektrik GmbH & Co. KG, AC 50 mV, 0.1 Hz to 4 MHz) of a solid electrolyte composition prepared by a method of the present invention and a solid electrolyte of an existing company.

FIG. 3 is a graph showing a comparison of discharge capacity of the solid electrolyte composition prepared by the method of the present invention and the solid electrolyte of an existing company when an LFP (LiFePO₄) electrode is used as a commercially available electrode.

FIG. 4 is a graph showing a comparison of discharge capacity of the solid electrolyte composition prepared by the method of the present invention and the solid electrolyte of an existing company when an LCO (LiCoO₂) electrode is used.

FIG. 5 is a graph showing a comparison of the change in discharge capacity of the solid electrolyte composition prepared by the method of the present invention and the solid electrolyte of an existing company.

### MODES OF THE INVENTION

Hereinafter, a method of preparing a solid electrolyte composition for a lithium secondary battery according to a preferred embodiment of the present invention will be described in detail.

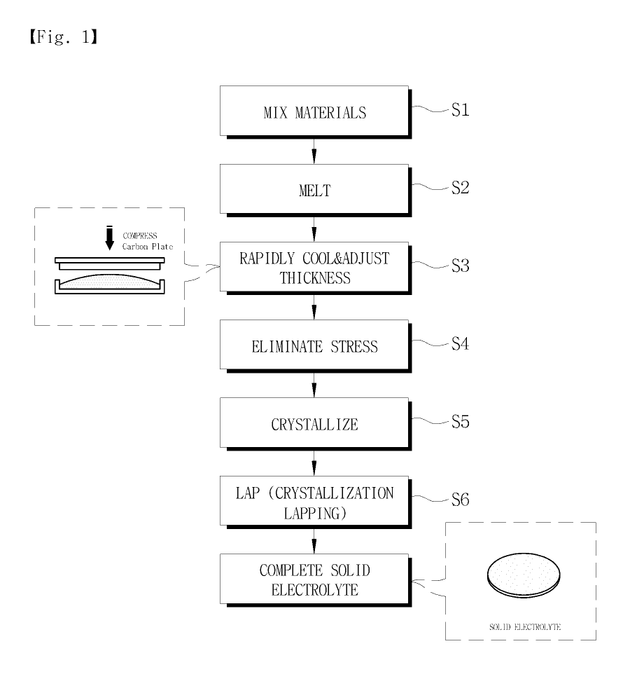

Referring to FIG. 1, a method of preparing a solid electrolyte composition for a lithium secondary battery according to the present invention includes: mixing materials including Li₂O, SiO₂, TiO₂, P₂O₅, BaO, Cs₂O and V₂O₅ (S1); melting the mixed materials (S2); rapidly cooling the molten materials at room temperature and compressing the molten materials to form electrolyte glass having a predetermined thickness (S3); heating the electrolyte glass to eliminate stress at a predetermined temperature range (S4); heating the electrolyte glass to a higher temperature range higher than in the step of heating the electrolyte glass to eliminate stress to be crystallized (S5); and precisely adjusting a thickness of the electrolyte glass by lapping the electrolyte glass (S6).

In the step of mixing the materials (S1), 5 to 8 wt % of Li₂O, 2 to 5 wt % of SiO₂, 30 to 35 wt % of TiO₂, and 56 to 60 wt % of P₂O₅ are mixed as main components, 0.1 to 2 wt % of BaO and 0.1 to 2 wt % of Cs₂O are mixed to impart mechanical strength, and 0.5 to 2 wt % of V₂O₅ is mixed to increase lithium ion conductivity.

In the step of melting the mixed materials (S2), the mixed materials are introduced into a platinum crucible to suppress second phases (AIPO₄) and are heated at a rate of 10° C./min, and the melting process is progressed by maintaining the mixed materials in an air atmosphere at a temperature of 1300 to 1450° C. for a predetermined time, preferably, for 3 hours.

Then, in the step of rapidly cooling and adjusting a thickness (S3), the molten materials are rapidly cooled at room temperature and are compressed using a carbon plate preheated to a predetermined temperature, preferably, to about 300° C. to form electrolyte glass having a predetermined thickness. In this way, it is advantageous in that there is no need for separate cutting and molding processes because the molten materials are taken out to be rapidly cooled and compressed to adjust the thickness thereof.

In the step of eliminating stress (S4), the electrolyte glass is heated at a rate of 10° C./min and is maintained at a temperature range of 500 to 600° C. for a predetermined time to eliminate stress. When this step of eliminating stress is not performed, cracks may be formed in the electrolyte glass.

Subsequently, the electrolyte glass from which stress is eliminated is heated at a rate of 10° C./h and is maintained in an air atmosphere at a temperature of 900 to 1000° C. for 5 to 15 hours without atmosphere control to be crystallized (S5). The electrolyte glass passing through this crystallization process has a lithium ion conductivity of about 6.5×10⁻⁴ S/cm which is increased compared to an existing solid electrolyte.

After the electrolyte glass is thus crystallized, the thickness of the electrolyte glass is precisely adjusted by lapping, thereby completing the electrolyte glass (S6).

The electrolyte glass prepared as above is determined to have a lithium ion conductivity of 6.5×10⁻⁴ S/cm which is increased about sixfold compared to an existing solid electrolyte, and has improved discharge capacity and stability.

The following Table 1 is data showing a comparison of the electrolyte glass according to the preparation method of the present invention (Example) and a solid electrolyte of an existing company (OHARA) (Comparative Example). The value of each component is shown in weight percent in Table 1.

TABLE 1

| | | | | | | | | Lithium |
|---|---|---|---|---|---|---|---|---|
| | | | | | | | | ion con- |
| | | | | | | | | ductivity |
| | Li₂O | TiO₂ | SiO₂ | P₂O₅ | BaO | Cs₂O | V₂O₅ | (LIC)(S/cm) |
| Exam- | 5.2 | 34.5 | 2.8 | 56 | 1.5 | 1 | 1.5 | 6.5 × 10⁻⁴ |
| ple | | | | | | | | |
| Com- | 3 | 34.3 | 6 | 55.7 | — | — | — | 1.0 × 10⁻⁴ |
| par- | | | | | | | | |
| ative | | | | | | | | |
| Exam- | | | | | | | | |
| ple | | | | | | | | |

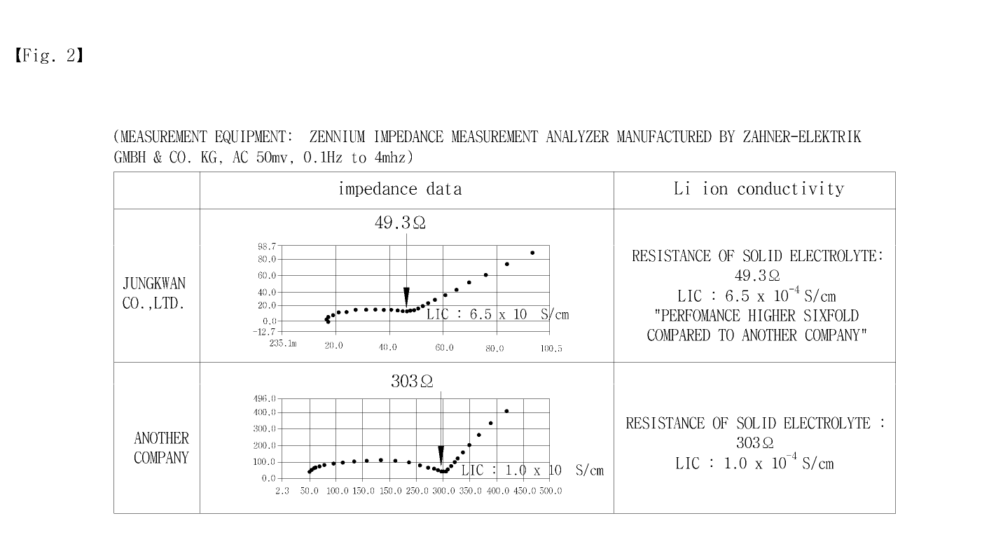

FIG. 2 shows impedance data (measurement equipment: Zennium impedance measurement analyzer manufactured by ZAHNER-elektrik GmbH & Co. KG, AC 50 mV, 0.1 Hz to 4 MHz) of the Example and Comparative Example. The LIC (lithium ion conductivity) of the Example and Comparative Example calculated by a graph of FIG. 2 was determined to be 6.5×10⁻⁴ S/cm and 1.0×10⁻⁴ S/cm, respectively. Consequently, the LIC of the solid electrolyte glass of the present invention (Example) was determined to be increased about sixfold compared to the solid electrolyte of an existing company (Comparative Example).

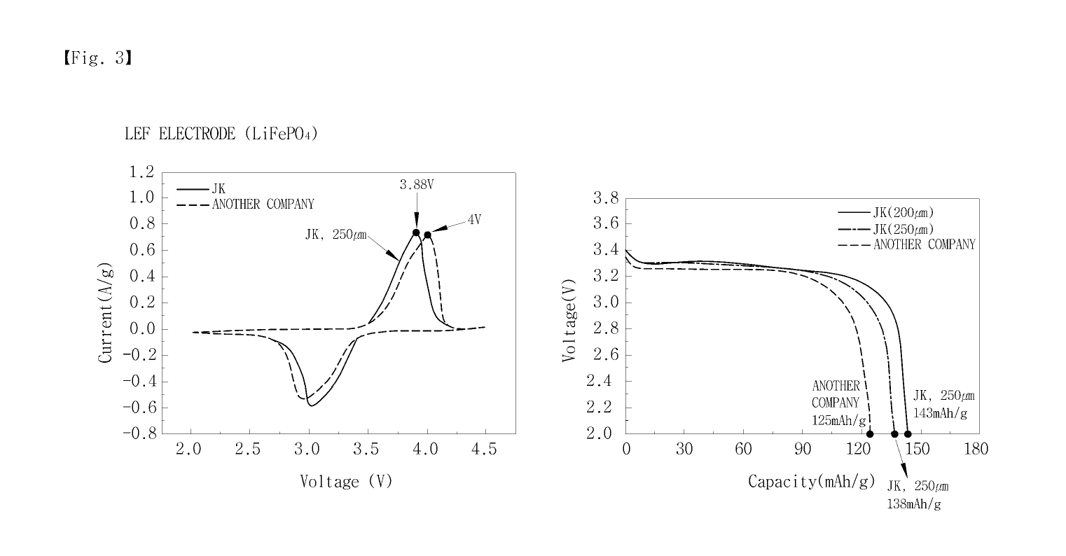

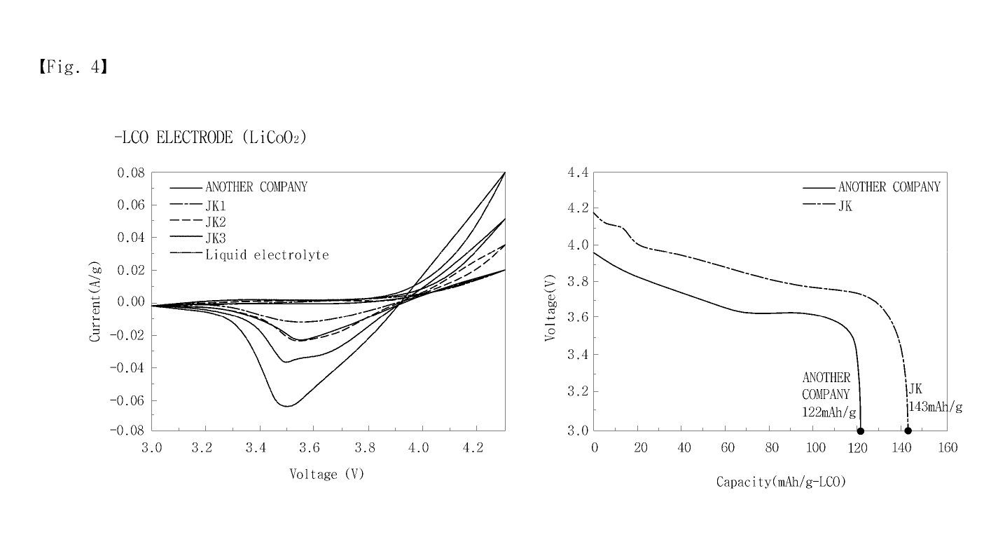

Further, FIG. 3 is a graph showing discharge capacity when an LFP (LiFePO₄) electrode is used as a commercially available electrode, and FIG. 4 is a graph showing discharge capacity when an LCO (LiCoO₂) electrode is used. It was determined that discharge capacity was increased 10.4% when an LFP (LiFePO₄) electrode was used, and discharge capacity was increased 17.2% when an LCO (LiCoO₂) electrode is used. For reference, the measurement result of an example of the present invention is marked as JK, and the measurement result of a comparative example is marked as another company in FIGS. 3 and 4.

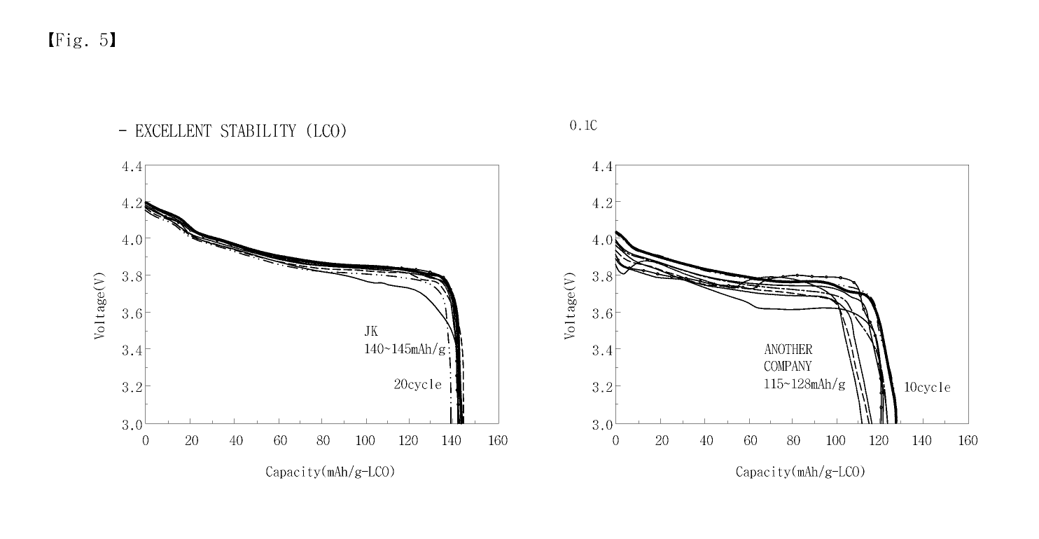

Moreover, when discharge capacity of the solid electrolyte glass of the present invention (Example) and the solid electrolyte of an existing company (Comparative Example) are compared as shown in FIG. 5, almost no change in discharge capacity was observed in the solid electrolyte glass of the present invention while the solid electrolyte of an existing company had severe changes in discharge capacity and was unstable, showing a voltage drop phenomenon, etc. The measurement result of an example of the present invention is marked as JK (left graph in the drawing), and the measurement result of a comparative example is marked as another company (right graph in the drawing) in FIG. 5, as well.

Accordingly, it can be seen that the solid electrolyte glass of the present invention has improved discharge capacity and stability as compared to an existing solid electrolyte.

Furthermore, the solid electrolyte composition for a lithium secondary battery prepared by the preparation method of the present invention may be applicable to coating materials of an existing separation membrane by being prepared as powder through a milling process after crystallization. Accordingly, when the solid electrolyte composition of the present invention is prepared as powder and coated on a separation membrane, the performance of a lithium secondary battery may be further enhanced due to high lithium ion conductivity.

The solid electrolyte composition may be prepared as powder having an average particle size of 1 μm by milling at a rate of 15,000 to 20,000 rpm using an air jet mill.

Consequently, glass type and powder type solid electrolytes have high chemical and thermal stability and high mechanical strength, and are easy to handle, and thus may be applicable to a main power source of a mobile device such as a mobile phone, laptop or the like and batteries of hybrid cars, electric cars, etc.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

### Industrial Applicability

The present invention may be applicable to a lithium secondary battery.

1. A method of preparing a solid electrolyte composition for a lithium secondary battery, comprising:
(a) mixing materials including Li₂O, SiO₂, TiO₂, P₂O₅, BaO, Cs₂O and V₂O₅;
(b) melting the mixed materials;
(c) rapidly cooling the molten materials at room temperature and compressing the molten materials using a preheated plate to form electrolyte glass;
(d) heating the electrolyte glass to eliminate stress at 500 to 600° C.;
(e) heating the electrolyte glass to a temperature range higher than in the step of heating the electrolyte glass to eliminate stress to be crystallized; and
(f) precisely adjusting a thickness of the electrolyte glass by lapping the electrolyte glass.

2. The method of claim 1, wherein 5 to 8 wt % of Li₂O, 2 to 5 wt % of SiO₂, 30 to 35 wt % of TiO₂, 56 to 60 wt % of P₂O₅, 0.1 to 2 wt % of BaO, 0.1 to 2 wt % of Cs₂O and 0.5 to 2 wt % of V₂O₅ are mixed in the step (a).

3. The method of claim 1, wherein the mixed materials are introduced into a platinum crucible and are heated at a rate of 10° C./min to become molten in an air atmosphere at a temperature of 1300 to 1450° C. in the step (b).

4. The method of claim 1, wherein the molten materials are compressed using a preheated carbon plate to be formed as electrolyte glass in the step (c).

5. The method of claim 1, wherein the temperature of the electrolyte glass is increased at a rate of 10° C./min to eliminate stress at 500 to 600° C. in the step (d).

6. The method of claim 1, wherein the electrolyte glass is heated at a rate of 10° C./h and is maintained in an air atmosphere at a temperature of 900 to 1000° C. for 5 to 15 hours to be crystallized in the step (e).

7. A method of preparing a solid electrolyte composition for a lithium secondary battery, comprising:
(a) mixing 5 to 8 wt % of Li₂O, 2 to 5 wt % of SiO₂, 30 to 35 wt % of TiO₂, 56 to 60 wt % of P₂O₅, 0.1 to 2 wt % of BaO, 0.1 to 2 wt % of Cs₂O and 0.5 to 2 wt % of V₂O₅;
(b) introducing the mixed materials into a platinum crucible and heating the mixed materials at a rate of 10° C./min to melt in an air atmosphere at a temperature of 1300 to 1450° C.;
(c) rapidly cooling the molten materials at room temperature and compressing the molten materials using a preheated carbon plate to form electrolyte glass;
(d) heating the electrolyte glass at a rate of 10° C./min to eliminate stress at 500 to 600° C.;
(e) heating the electrolyte glass at a rate of 10° C./h and maintaining the electrolyte glass in an air atmosphere at a temperature of 900 to 1000° C. for 5 to 15 hours to be crystallized; and
(f) precisely adjusting a thickness of the electrolyte glass by lapping the electrolyte glass.
